(19) United States
(12) Patent Application Publication
(10) Pub. No.: US 2008/0254322 A1
(43) Pub. Date: Oct. 16, 2008

(54) Apparatus With Increased Magnetic Anisotropy And Related Method

(75) Inventors: Timothy J. Klemmer, Pittsburgh, PA (US); Yukiko Kubota, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/733,815

(22) Filed: Apr. 11, 2007

(51) Int. Cl. G11B 5/39

(52) U.S. Cl. 428/811.2; 428/811; 977/838

(57) ABSTRACT

An apparatus includes a thermally insulating substrate, an energy absorbing layer on the thermally insulating substrate, and a flash annealed magnetic layer on the energy absorbing layer. The flash annealed magnetic layer may be configured for data storage. A method includes providing a thermally insulating substrate, depositing an energy absorbing layer on the thermally insulating substrate, depositing a magnetic layer on the energy absorbing layer, and flash annealing the magnetic layer.

### STATEMENT REGARDING FEDERALLY SPONSORED RESEARCH OR DEVELOPMENT

This invention was made with United States Government support under Agreement No. 70NANB1H3056 awarded by the National Institute of Standards and Technology (NIST). The United States Government has certain rights in the invention.

### FIELD OF THE INVENTION

The invention relates generally to an apparatus with increased magnetic anisotropy and a related method.

### BACKGROUND INFORMATION

Materials with increased magnetic anisotropies are desirable for various applications such as, for example, applications in the data storage industry where there is a continuous need to increase storage densities. Data storage media that can hold densities approaching 1 Tbit/in² will require materials with magnetic anisotropies greater than conventional media materials. There are known bulk permanent magnetic materials having crystalline phases with magnetocrystalline anisotropy which theoretically can hold densities greater than 1 Tbit/in2. For bulk permanent magnetic materials, special heat treatments are typically used to control the phase formation and microstructure to optimize the materials properties. In order to incorporate these materials into a data storage media the correct crystalline phase must be obtained within a microstructure of fine, nanocrystalline, exchange decoupled or partially exchange decoupled grains.

Thin film manufacturing techniques that can form nanocrystalline grains do not produce the correct phase on their own. For example, the FePt family is typically deposited as the face centered cubic (fcc) phase and subsequent annealing is needed to transform (i.e. chemically order) the material into the high anisotropy L1₀ phase. The rare earth families including, for example, Nb₂Fe₁₄B, SmCo₅ and Sm₂Co₁₇ are typically deposited as an amorphous phase and subsequent annealing is needed to transform to the high anisotropy phases. Although the annealing step is required to produce the high anisotropy phases, techniques such as rapid thermal annealing and furnace annealing causes coarsening of the grain structure thereby eliminating the required nanocrystalline structure. It would be desirable to rectify the competition between the reactions of the required phase transformation and the detrimental coarsening of the microstructure so as to provide for increased magnetic anisotropies.

There is identified, therefore, a need for improved materials having increased magnetic anisotropies. There is also identified a need for improved data storage media that overcomes limitations, disadvantages, and/or shortcomings of known data storage media.

### SUMMARY OF THE INVENTION

The invention meets the identified need, as well as other needs, as will be more fully understood following a review of this specification and drawings.

An aspect of the present invention is to provide an apparatus including a thermally insulating substrate, an energy absorbing layer on the thermally insulating substrate, and a flash annealed magnetic layer on the energy absorbing layer. The flash annealed magnetic layer may have a magnetic anisotropy in the range of about 0.5×10⁷ ergs/cc to about 30×10⁷ ergs/cc.

Another aspect of the present invention is to provide a data storage media including a thermally insulating substrate, an energy absorbing layer on the thermally insulating substrate, and a flash annealed magnetic recording layer on the energy absorbing layer. The flash annealed magnetic layer may have a magnetic anisotropy in the range of about 0.5×10⁷ ergs/cc to about 30×10⁷ ergs/cc.

A further aspect of the present invention is to provide a method that includes providing a thermally insulating substrate, depositing an energy absorbing layer on the thermally insulating substrate, depositing a magnetic layer on the energy absorbing layer, and flash annealing the magnetic layer. The flash annealing may include exposing the magnetic layer to a pulse of light for a time in the range of about 0.05 milliseconds to about 1,000 milliseconds. The pulse of light may have a wavelength in the range of about 200 nm to about 1,000 nm. In addition, the flash annealing may be performed at a temperature in the range of about 300° C. to about 2,200° C.

These and other aspects of the present invention will be more apparent from the following description.

### BRIEF DESCRIPTION OF THE DRAWINGS

FIG. 1 is a pictorial representation of a data storage system that may utilize a thin film structure constructed in accordance with the invention.

FIG. 2 is a schematic illustration of a thin film structure constructed in accordance with the invention.

FIGS. 3a, 3b and 3c graphically illustrate temperature vs. time for a substrate with varying thermal conductivities.

FIG. 4 is a schematic illustration of a thin film structure constructed in accordance with the invention.

FIG. 5 is a table illustrating layer thickness and thermal properties for the structure set forth in FIG. 4.

FIGS. 6a and 6b graphically illustrate temperature change for the structure set forth in FIG. 4.

FIG. 7 is a schematic illustration of a thin film structure constructed in accordance with the invention.

### DETAILED DESCRIPTION

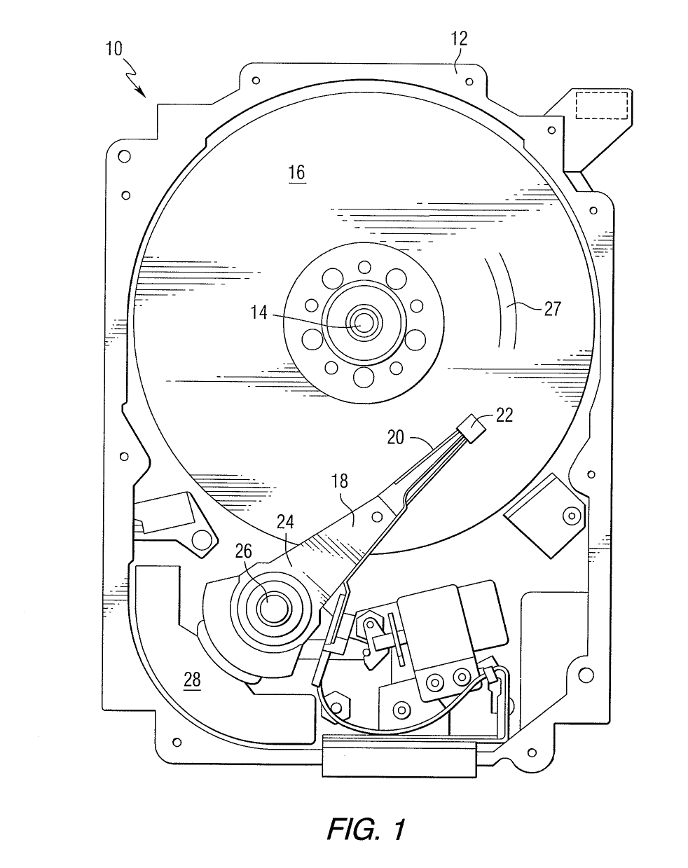

FIG. 1 is a pictorial representation of a data storage system 10 that can include aspects of this invention. The data storage system 10 includes a housing 12 (with the upper portion removed and the lower portion visible in this view) sized and configured to contain the various components of the data storage system 10. The data storage system 10 includes a spindle motor 14 for rotating at least one storage media, such as a magnetic recording medium 16, which may be a perpendicular, longitudinal and/or tilted magnetic recording medium, within the housing 12. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

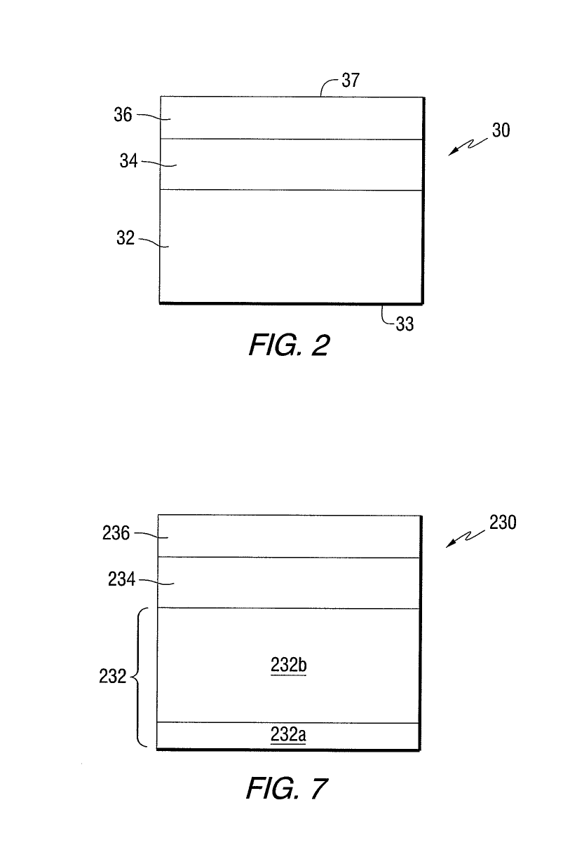

Referring to FIG. 2, there is illustrated a thin film structure 30 constructed in accordance with the invention. The structure 30 may be, for example, a data storage media. The structure 30 includes a thermally insulating substrate 32 having a bottom surface 33, an energy absorbing layer 34 on the substrate 32, and a magnetic layer 36 on the energy absorbing layer 34. The magnetic layer 36 includes a top surface 37. In accordance with the invention, the magnetic layer 36 is flash annealed to phase transform the crystalline structure of the magnetic layer 36 from a substantially face centered cubic phase (fcc) to a substantially L1₀ phase. This results in the magnetic layer 36 having an increased magnetic anisotropy. For example, the flash annealed magnetic layer 36 may have a magnetic anisotropy in the range of about 0.5×10⁷ erg/cc to about 30×10⁷ erg/cc. The magnetic layer 36 having an increased magnetic anisotropy can be advantageously used as, for example, a data storage layer for recording information wherein high magnetic anisotropy materials allow for increasing storage densities of a data storage media.

The thermally insulating substrate 32 may include glass, ceramic or combinations thereof. The substrate 32 may have a thermal conductivity, k, in the range of about 0.7 W/mK to about 2 W/mK. In addition, the substrate 32 may have a thickness in the range of about 0.1 mm to about 5.0 mm.

The energy absorbing layer 34 may include Ta, Ti, Re, Be, Nb, Ni—Cr, or any of these metals combined with an oxide. In addition, the energy absorbing layer 34 may have a thickness in the range of about 2 nm to about 5,000 nm. The layer 34 needs to be able to withstand the flash annealing temperature range of about 300° C. to about 2,200° C., and needs to be able to absorb the light energy from the flash annealing in the wavelengths the light source irradiates. Such wavelengths may be, for example, in the range of about 200 nm to about 1,000 nm. The absorbance of the light energy from the flash annealing by the energy absorbing layer 34 assists in retaining heat in the structure 30 to promote the desired phase transformation in the magnetic layer 36.

The magnetic layer 36 may include FePt, CoPt, N₂dFe₁₄B₄, SmCo₅, YCo₃, Sm₂Co₁₇, FePd, MnAl, CrPt₃, RE₂Fe₁₄B₄, RECo₅, RE₂CO₁₇ wherein RE represents rare earth elements that may include, for example, Sm, Y, Pr, Ce, La, Nd, or Tb. The magnetic layer 36 may have a thickness in the range of about 1 nm to about 100 nm.

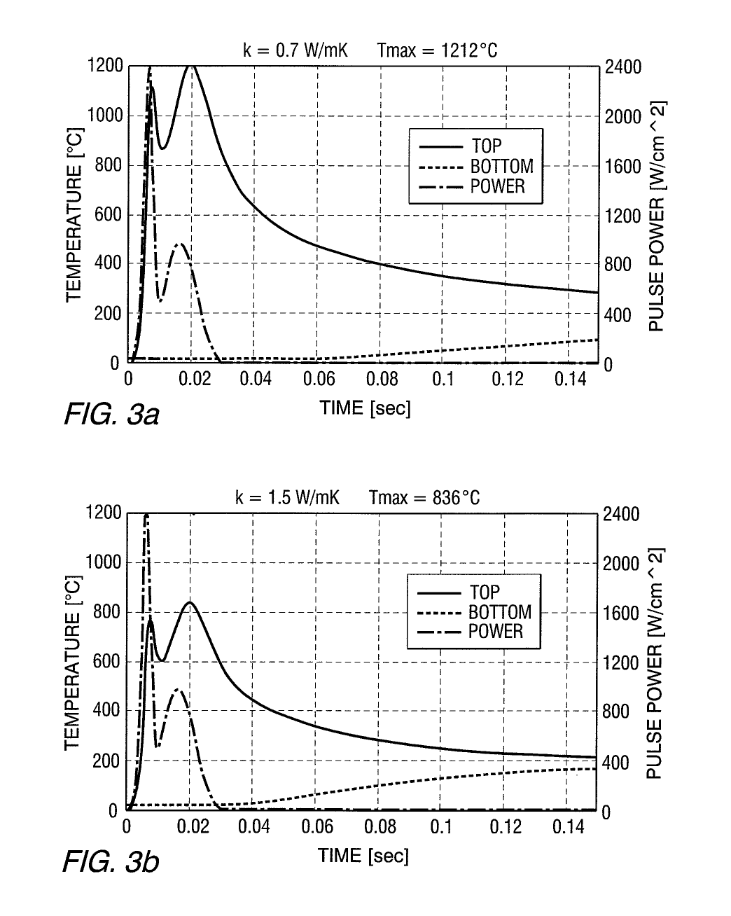

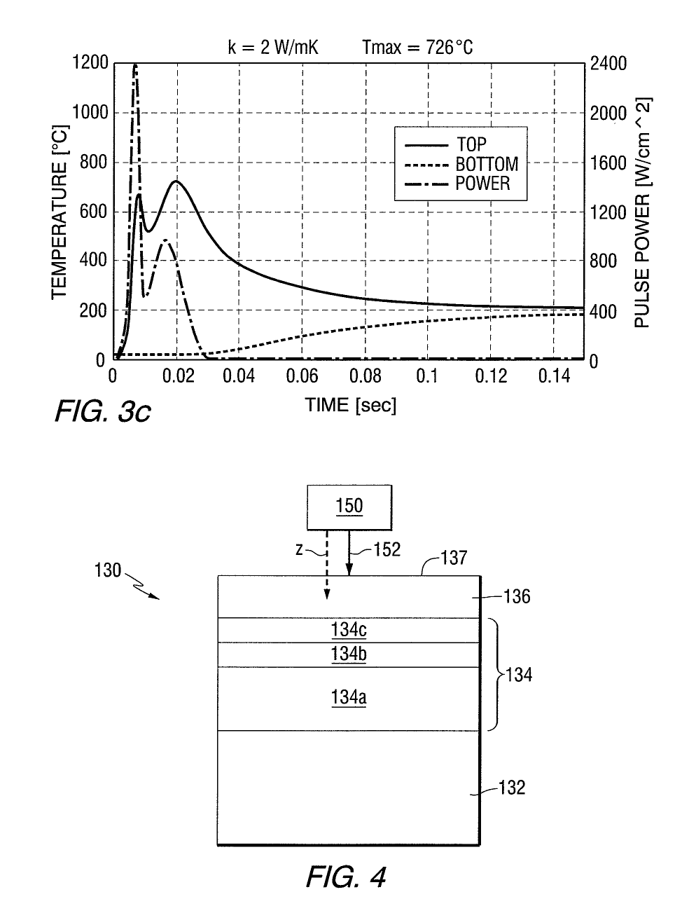

The thin film structure 30 illustrated in FIG. 2 is designed to provide rapid heating and cooling of the magnetic layer 36 where the phase transformation occurs. The use of the thermally insulating substrate 32 assists in achieving the rapid heating and cooling of the magnetic layer 36. When the thermally insulating substrate 32 is used the magnetic layer 36 cools quickly and the bottom surface 33 of the substrate 32 heats very little (see, for example, FIGS. 3a-3c). The rapid cooling helps to achieve the desired phase transformation. However in comparison, if a substrate is used that is not considered to be a thermally insulating substrate, e.g. an Si substrate, the film structure and the substrate quickly come into thermal equilibrium with each other at very high temperatures. In this case, the substrate and film structure will cool together by conventional cooling methods (e.g. radiation, convection and/or conduction) with the external environment and not allow for the desired phase transformation.

FIGS. 3a, 3b and 3c graphically illustrate the advantages of using the thermally insulating substrate 32 by plotting simulations of temperature vs. time at the top surface 37 (indicated as “TOP” in FIGS. 3a-3c) of the magnetic layer 36 formed of FePt and at the bottom surface 33 (indicated as “BOTTOM” in FIGS. 3a-3c) of the substrate 32 for substrates with different thermal conductivities, k. Specifically, FIGS. 3a, 3b and 3c illustrate that the maximum temperatures, Tmax, clearly increase as the thermal conductivity, k, decreases. The “POWER” of the flash annealing lamp used to obtain the data in FIGS. 3a-3c is also shown in FIGS. 3a, 3b and 3c.

Referring to FIG. 4, there is illustrated a thin film structure 130 constructed in accordance with the invention wherein the energy absorbing layer 134 includes multiple layers. The structure 130 includes a thermally insulating substrate 132, an energy absorbing layer 134 on the substrate 132, and a magnetic layer 136 on the energy absorbing layer 134. The energy absorbing layer 134 may include, for example, a layer 134a of Ru, a layer 134b of Pt, and a layer 134c of Ta. It will be appreciated that other materials can be utilized to form the layer 134 in accordance with the invention. For example, layer 134a may be formed of: RuCu, OsCu, RuC, RuB, or RuCoCr; layer 134b may be formed of RuCu; and layer 134c may be formed of Cu. Thus, it will be appreciated that two or more layers formed of, for example, the example materials listed herein for layers 134a, 134b, or 134c may be provided to form the energy absorbing layer 134 having multiple layers in accordance with the invention.

The magnetic layer 136 is flash annealed to transform the crystalline structure of the magnetic layer 136 from a substantially face centered cubic phase (fcc) to a substantially L1₀ phase. This results in the increase of the magnetic anisotropy of the magnetic layer 136.

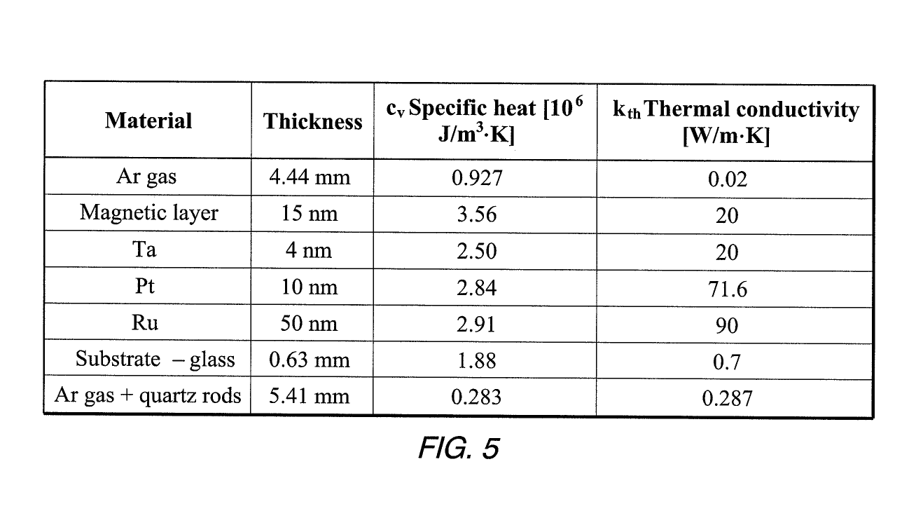

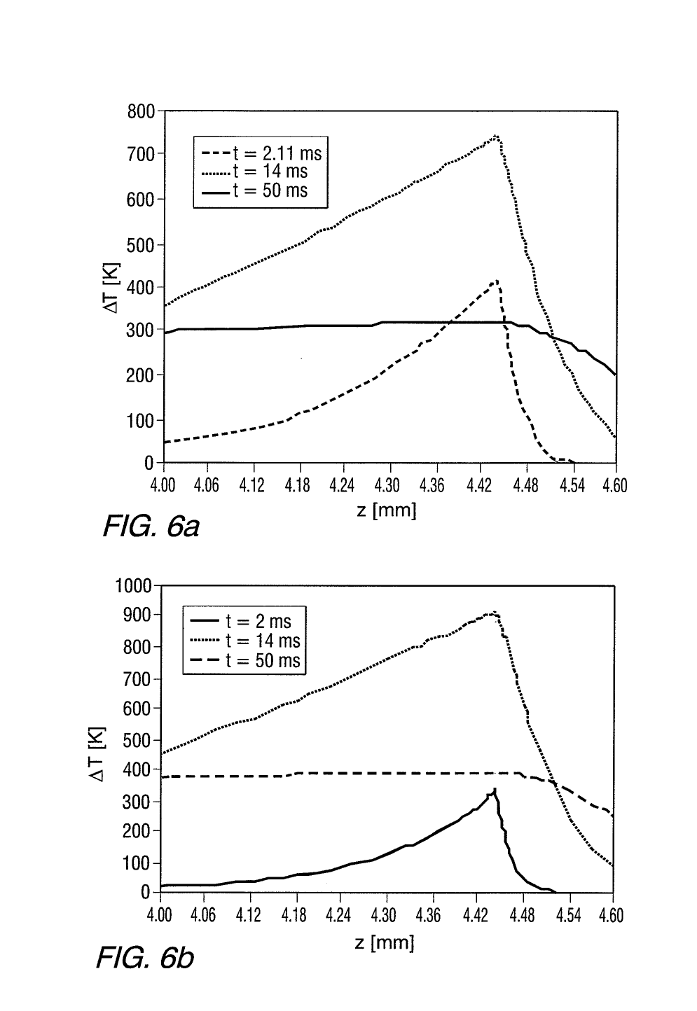

FIGS. 5, 6a and 6b are provided to illustrate the advantages of the energy absorbing layer of the invention utilizing the structure 130. Specifically, FIG. 5 sets forth layer thickness and thermal properties for the structure 130 as used to produce simulation results set forth in FIGS. 6a and 6b. In these simulations, there is a space of approximately 4.44 mm between a flash annealing lamp 150 and a top surface 137 of the magnetic layer 136 of the structure 130 wherein the lamp 150 applies a pulse of light, as represented by arrow 152, to the layer 136. This space for the simulation assumes flowing Ar gas between the lamp 150 and the structure 130. The simulation takes into consideration that thermal energy is consumed in the flash annealing process during the phase transformation, during diffusion into the substrate, and via radiation into the environment such as, for example, via the Ar gas and quartz rods used in the flash annealing.

FIGS. 6a and 6b graphically illustrate temperature change for pulses of light applied for discrete time periods of about 2 milliseconds, 14 milliseconds, and 50 milliseconds. In FIGS. 6a and 6b, the temperature change is plotted versus the distance “z”, which is the distance from the flash annealing lamp 150 as represented by dashed line “z”. For example, “z” is approximately 4.44 mm at the top surface 137. FIG. 6a shows the results without the energy absorbing layer 134, i.e. the layer 134 is removed, while FIG. 6b shows the results with the energy absorbing layer 134. Clearly higher temperatures can be achieved in the magnetic layer 136, as shown in FIG. 6b, where the phase transformation occurs when using the energy absorbing layer 134.

Referring to FIG. 7, there is illustrated a thin film structure 230 constructed in accordance with the invention wherein the substrate 232 includes multiple layers. The structure 230 includes a substrate 232, an energy absorbing layer 234 on the substrate 232, and a magnetic layer 236 on the energy absorbing layer 234. The substrate 232 may include (i) a layer 232a formed of, for example Si or other suitable material that is not considered thermally insulating (i.e. having a thermal conductivity above the desired range for forming a thermally insulating substrate as described herein), and (ii) a thermally insulating layer 232b formed of, for example, SiO₂, SiN or any other thermally insulating material having a suitable thermal conductivity as described herein. The layers 232a and 232b combine to provide substrate 232 that is sufficiently thermally insulating for the present invention. The layer 232b may have a thickness in the range of about 1 μm to about 1 mm in order for the substrate 232 to provide sufficient thermal insulation. It will be appreciated that other materials and/or layers can be utilized to form the substrate 232 so long as the substrate 232 overall can provide sufficient thermal insulation in accordance with the invention.

The invention encompasses the method for forming the thin film structures described herein. Specifically, the method includes providing a thermally insulating substrate (e.g. substrate 32), depositing an energy absorbing layer (e.g. layer 34) on the thermally insulating substrate, depositing a magnetic layer (e.g. magnetic layer 36) on the energy absorbing layer, and flash annealing the magnetic layer. The flash annealing may include exposing the magnetic layer to a pulse of light for a time in the range of about 0.05 milliseconds to about 1,000 milliseconds. The flash annealing may be performed in a non-oxidizing environment such as, for example, a vacuum, or an environment of N, Ar, Ne, or Kr.

A flash annealing tool such as, for example, the FLA-100 produced by Nanoparc/FHR may be used to provide the desired flash annealing for the invention.

Whereas particular aspects have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims. For example, it will be appreciated that the invention was described herein for illustration purposes only as used for data storage applications, but the invention may also have utility in applications other than data storage where it is desirable to have increased magnetic anisotropy and phase transformation at shorter times using flash annealing.

What is claimed is:

1. An apparatus, comprising:
a thermal insulating substrate;
an energy absorbing layer on the substrate; and
a flash annealed magnetic layer on the energy absorbing layer.

2. The apparatus of claim 1, wherein said thermal insulating substrate has a thickness in the range of about 0.1 mm to about 5 mm.

3. The apparatus of claim 1, wherein said thermal insulating substrate includes multiple layers.

4. The apparatus of claim 1, wherein said energy absorbing layer includes Ta, Ti, Re, Be, Nb, Ni—Cr, or any of these metals combined with an oxide.

5. The apparatus of claim 4, wherein said energy absorbing layer has a thickness in the range of about 2 nm to about 5,000 nm.

6. The apparatus of claim 1, wherein said energy absorbing layer includes multiple layers.

7. The apparatus of claim 1, wherein said flash annealed magnetic layer includes FePt, CoPt, N₂dFe₁₄B₄, SmCo₅, YCo₃, Sm₂Co₁₇, FePd, MnAl, CrPt₃, RE₂Fe₁₄B₄, RECo₅, RE₂Co₁₇ wherein RE represents rare earth elements that may include Sm, Y, Pr, Ce, La, Nd, or Tb.

8. The apparatus of claim 7, wherein said flash annealed magnetic layer has a thickness in the range of about 1 nm to about 100 nm.

9. The apparatus of claim 1, wherein said flash annealed magnetic layer has a magnetic anisotropy in the range of about 0.5×10⁷ erg/cc to about 30×10⁷ erg/cc.

10. A data storage media, comprising;
a thermal insulating substrate;
an energy absorbing layer on the substrate; and
a flash annealed magnetic recording layer on the energy absorbing layer.

11. The data storage media of claim 10, wherein said flash annealed magnetic recording layer includes FePt, CoPt, N₂dFe₁₄B₄, SmCo₅, YCo₃, Sm₂Co₁₇, FePd, MnAl, CrPt₃, RE₂Fe₁₄B₄, RECo₅, RE₂Co₁₇ wherein RE represents rare earth elements that may include Sm, Y, Pr, Ce, La, Nd, or Tb.

12. The data storage media of claim 10, wherein said flash annealed magnetic recording layer has a thickness in the range of about 1 nm to about 100 nm.

13. The data storage media of claim 10, wherein said flash annealed magnetic recording layer has a magnetic anisotropy in the range of about 0.5×10⁷ erg/cc to about 30×10⁷ erg/cc.

14. A method, comprising:
providing a thermal insulating substrate;
depositing an energy absorbing layer on the substrate;
depositing a magnetic layer on the energy absorbing layer; and
flash annealing the magnetic layer.

15. The method of claim 14, wherein the flash annealing includes exposing the magnetic layer to a pulse of light for a time in the range of about 0.05 milliseconds to about 1,000 milliseconds.

16. The method of claim 15, wherein the pulse of light has a wavelength in the range of about 200 nm to about 1,000 nm.

17. The method of claim 14, wherein the flash annealing is performed at a temperature in the range of about 300° C. to about 2,200° C.

18. The method of claim 14, wherein the flash annealed magnetic layer has a magnetic anisotropy in the range of about 0.5×10⁷ erg/cc to about 30×10⁷ erg/cc.

19. The method of claim 14, further comprising configuring the magnetic layer for data storage.

20. A thin film structure constructed in accordance with the method of claim 14.
